(19) United States
(12) Patent Application Publication
(10) Pub. No.: US 2016/0042544 A1
(43) Pub. Date: Feb. 11, 2016

(54) METHOD AND DEVICE FOR CREATING A RECORDING OF AN OBJECT WHICH LIGHTS UP IN A PULSED MANNER

(71) Applicant: Robert Bosch GmbH, Stuttgart (DE)

(72) Inventors: Frank MOESLE, Stuttgart (DE); Daniela WEISS, Hildesheim (DE); Paul RUHNAU, Leonberg-Hoefingen (DE); Dimitrios BARIAMIS, Hildesheim (DE)

(21) Appl. No.: 14/778,902

(22) PCT Filed: Feb. 24, 2014
(86) PCT No.: PCT/EP2014/053501

§ 371 Date: Sep. 21, 2015

(30) Foreign Application Priority Data
Mar. 20, 2013 (DE) 10 2013 204 935.8

(51) Int. Cl. G06T 11/60; G06T 7/20; G06T 7/00; G06K 9/00; G06T 5/10

(52) U.S. Cl. CPC G06T 11/60; G06K 9/00818; G06T 5/10; G06T 7/0028; G06K 9/00825; G06T 7/20; G06T 2207/30252

(57) ABSTRACT

A method is provided for creating a recording of an object which lights up in a pulsed manner for a vehicle. The method includes a step of reading in of two images, the object being depicted at least in one section of each of the two images, a step of determining an apparent motion of the object between two recording times of the two images, a step of transforming at least one of the two images using the apparent motion in order to obtain two adapted images, in which the object is represented in the same size, and a step of merging the two adapted images, the object being superimposed in a congruent manner during merging, in order to create the recording of the object which lights up in a pulsed manner.

### FIELD OF THE INVENTION

The present invention relates to a method for creating a recording of an object which lights up in a pulsed manner for a vehicle, to a corresponding device for creating a recording of an object which lights up in a pulsed manner for a vehicle and a corresponding computer program product.

### BACKGROUND INFORMATION

In road traffic there are pulsed light sources, in particular periodically pulsed light sources, for example, as variable message signs, taillights, or turn signals of vehicles. Driver assistance systems, predictive sensors or other imaging methods for a vehicle record the vehicle surroundings, in order to further evaluate the information obtained therefrom, in which case pulsed light sources present a particular challenge.

Pulsed objects are, for example, the currently widely used LED lights, whose brightness is regulated with the aid of pulse width modulation. In everyday life, this lighting technology is used, for example, in variable message signs and taillights of modern vehicle types. For a camera, these objects are sometimes recognizable in only a few frames or, in unfavorable constellations, potentially not recognizable at all, particularly also if parts of the object are pulsed differently. This often occurs in the case of variable message signs, the circle and individual numbers or pictograms of which are controlled with different phases.

### SUMMARY

Against this background, a method is introduced according to the present invention for creating a recording of an object which lights up in a pulsed manner for a vehicle, in addition, a device for creating a recording of an object which lights up in a pulsed manner for a vehicle, which uses this method and, finally, a corresponding computer program product according to the main claims. Advantageous embodiments result from the respective subclaims and the following description.

Objects which light up in a pulsed manner may be accurately reproduced by superimposing a plurality of image recordings. If the image recording unit, for example, a camera, or the object to be recorded moves, it is possible to generate a geometrically comparable and, therefore, superimposable representation of the object which lights up in a pulsed manner by a transformation of at least one of the recorded images.

A method for creating a recording of an object which lights up in a pulsed manner for a vehicle includes the following steps:

reading in of two images, the object being depicted at least in one section of each of the two images;

determining an apparent motion of the object between two recording times of the two images;

transforming at least one of the two images using the apparent motion in order to obtain two adapted images, in which the object is represented in the same size; and

merging the two adapted images, the object being superimposed in a congruent manner during merging in order to create the recording of the object which lights up in a pulsed manner.

The method for creating a recording of an object which lights up in a pulsed manner may be carried out in a vehicle. The vehicle may be a motor vehicle, such as a passenger vehicle, a commercial vehicle and/or a motorcycle. The vehicle may include a driver assistance system. The driver assistance system may be designed to inform a driver of the vehicle about an object or a plurality of objects, such as, for example, a traffic sign, a variable message sign or a preceding vehicle. The object in such a case may be detected or identified. The object may emit light. The object may include a plurality of light sources. The light sources may be pulse-controlled. In such a case, different light sources of an object may be pulse-controlled with a different phase. The vehicle may include a camera or some other imaging system. The camera may be designed to record an image of the vehicle surroundings, in particular, in the driving direction ahead of the vehicle. An image may be understood to mean a piece of image information or a depiction of the vehicle surroundings. An image may also be understood to mean an image section. An object may be depicted on two consecutive images. The two images may have been recorded at two successive recording times. A portion of the pulsed light sources of an object having a plurality of pulsed light sources may be visible in one image. Another portion of the pulsed light sources may be visible in an image recorded at another recording time. All visible light sources of an object may be visible in two images. An object may move between two recording times. One recording location of a first image of the two images may differ spatially from a recording location of a second image of the two images. In the case of a recording location changing between the recording of the two images, a position of the object in the first image of the two images may differ from a position of the object in the second image of the two images. An object may have a different position in one image and/or a different geometric property such as, for example, a scaling or a restriction as compared to a second image. In order to superimpose in a congruent manner an object which is depicted in one section of each of the two images, it is possible to transform at least one image of the two images. Transforming may be understood to mean a distortion, shifting, scaling, shearing or a similar modification of at least one geometric property of an image. An adapted image may represent an image section of the image to be adapted.

A camera or an imaging system may record a plurality of images at one image rate. An image may be referred to as a frame. Thus, an image rate may be referred to as a frame rate. A frame rate may describe a particular number of images per unit of time. The reciprocal of the frame rate is called frame period. A frame period encompasses an exposure time for a frame and a time between two recorded frames. In order to record the frames or images, the sensor of the camera is exposed within each frame period. An object which lights up in a pulsed manner is switched on and off using a certain pulsing frequency and a (not necessarily constant) pulse duty factor. While a high pulsing frequency (for example, above 60 Hz) ensures that the object is easily or continually perceived by an observer, the successful detection of the object with a camera is dependent on the combination of frame rate, exposure time, pulsing frequency and pulse duty factor.

In addition, in the step of reading in, one image of the two images may be a synthetic image, which has been created on the basis of past images, or may be a recording of an object which lights up in a pulsed manner, which has been created according to the aforementioned method for creating a recording of an object which lights up in a pulsed manner. The synthetic image may have been created previously in the step of merging based on information from both adapted images. Thus, a recording of an object which lights up in a pulsed manner may be referred to as a synthetic image. Thus, information may be extracted from multiple past frames or images, stored in a new synthetic image and be continually updated for each new image or frame. The information stored in the synthetic image may be either the pixel intensities of the past frames, or an arbitrary function thereof. In other words, a new image from the camera and the synthetic image may be read in. An apparent motion of the object between the new image and the synthetic image may then be determined. Finally, the new image and/or the synthetic image may be transformed using the apparent motion, in order to obtain two adapted images, in which the object is represented in the same size. The adapted image from the camera and the adapted synthetic image may then be merged, the object being superimposed in a congruent manner during merging in order to create the recording of the object which lights up in a pulsed manner. The recording of the object which lights up in a pulsed manner may contain information both from the past images, i.e., from the synthetic image, and from the instantaneous image from the camera. The adapted synthetic image may be updated and saved, based on the adapted image from the camera or based on the created image of the object which lights up in a pulsed manner. Upon a renewed implementation of the introduced method, the synthetic image, together with a new image from the camera, may be read in and processed.

In addition, the apparent motion may be determined using a piece of information about a position change of a recording location of the two images. If the method for creating a recording of an object which lights up in a pulsed manner is carried out in a moving vehicle, it is possible to record two successive images from two different locations. Via a piece of information about the speed of the vehicle, it is possible to ascertain a piece of information about a position change of the recording location. A position change of the recording location of the two images may be determined using a piece of information about the length of the time interval and the information about the speed of the vehicle. An object represented in one section of a first image of the two images may change its position relatively in a second section of a second image of the two images in the event of a position change of the recording location. This may appear to an observer as a change of a position location of the object. This apparent motion of the object may be determined using a piece of information about the position change of the recording location of the two images.

It is also favorable if the apparent motion is determined using an object type of the object. As previously described, the object may be a traffic sign or a variable message sign. Traffic signs are generally mounted on the edge of the road at a predetermined height. Variable message signs may be mounted on the edge of the road at a predetermined height or on a sign gantry above a road. Thus, a position of the object relative to the vehicle may be determined via the object type. An apparent motion of the object may be determined from a predetermined position of the object relative to the vehicle.

The apparent motion may be determined using a predetermined position of the object. A predetermined position of the object may be provided by a navigation unit and simultaneously or alternatively by a database. The database or the navigation unit may be situated in the vehicle. The presence of variable message signs, traffic signs or other objects to be detected on a section of road may now already be recorded in the digital maps of the navigation devices. It is likely that in the future, this information will be able to refer in greater detail to the exact position of the variable message signs, in particular, also to the height thereof above the roadway, or other properties, such as the potential pulse frequencies, will be able to be provided. In order to be able to use the predetermined position of the object, a vehicle position may be ascertained with the aid of sensors such as, for example, a satellite positioning device. The vehicle position may be determined in response to satellite signals such as GPS or Galileo and/or in response to communication signals such as, for example, GSM, UMTS, LTE and/or WLAN. The vehicle position may be determined in response to driving dynamics sensors. In this case, a vehicle position may be understood to mean a piece of information about a geographic location, a position and/or a direction of movement of the vehicle. If a predetermined position of the object is known, a corresponding section of the image may be used and or transformed. The apparent motion, which has been determined using the predetermined position of the object, may be used for the transformation.

In addition, the apparent motion may be determined using object detection in each of the two images, in particular, in order to create the recording of a moving object which lights up in a pulsed manner. Vehicle taillights in particular may move over time. When using a sufficiently powerful detector, the apparent motion may alternatively be determined by detecting the object in each image. Alternatively, plausible object candidates may be generated and the object candidates may be tracked over time in order to determine the apparent motion.

In the process, the two adapted images may be merged using a local image operator and/or a pixel-by-pixel image operator. The image operator may prefer higher pixel intensities in one of the two images as compared to the other of the two images. For example, the image operator may be a maximum operator.

In one specific embodiment, a piece of position information of the object per image may be determined in the step of determining. In the step of transforming, at least one of the two images may be transformed using the position information in order to obtain two adapted images, in which the object is represented at the same position.

It is also favorable if in the step of reading in at least one additional image is read in. The object in this case may be depicted at least in one section of the at least one additional image. In the step of determining, the apparent motion of the object may be determined using the recording time of the at least one additional image. Thus, in the step of transforming, the at least one additional image may be transformed using the apparent motion in order to obtain an additional adapted image. In the process, the at least one additional adapted image may be merged in the step of merging with the two adapted images. In the process, the object may be superimposed in a congruent manner in order to create the recording of the object which lights up in a pulsed manner. In the case of an unfavorable ratio of the image rate, the exposure time and the pulsing frequency of the light sources of the object, a plurality of images may permit an improved recording of the object which lights up in a pulsed manner. It may be advantageous to merge at least three images into one recording of the object which lights up in a pulsed manner. It may also be advantageous to merge four, five or more images into one recording of the object which lights up in a pulsed manner.

A device for representing an object for a vehicle which lights up in a pulsed manner is designed to carry out the steps of a method for representing an object which lights up in a pulsed manner. The device includes the following features:

an interface for reading in two images, the object being depicted at least in one section of each of the two images;

a unit for determining an apparent motion of the object between two recording times of the two images;

a unit for transforming at least one of the two images using the apparent motion in order to obtain two adapted images, in which the object is represented in the same size; and

a unit for merging the two adapted images, the object being superimposed in a congruent manner during merging in order to create the recording of the object which lights up in a pulsed manner.

A device for representing an object for a vehicle which lights up in a pulsed manner is designed to carry out or implement the steps of the method for representing an object for a vehicle which lights up in a pulsed manner. With this embodiment variant of the present invention in the form of a device as well, it is possible to quickly and efficiently achieve the object underlying the present invention.

A device may be understood to mean an electrical device, which processes sensor signals and outputs control signals and/or data signals as a function thereof. The device may include an interface, which may be designed on the hardware and/or software side. In the case of a hardware design, the interfaces may be, for example, part of a so-called ASIC, which includes a wide variety of functions of the device. It is also possible, however, for the interfaces to be independent, integrated circuits or made at least partially of discrete elements. In the case of a software design, the interfaces may be software modules, which, for example, are present on a microcontroller alongside other software modules.

Also advantageous is a computer program product having program code, which may be stored on a machine-readable medium, such as a semiconductor memory, a hard disk memory, or an optical memory, and is used to carry out the method according to one of the previously described specific embodiments, if the program code is executed on a computer or a device. Thus, the steps of the method defined in the program code may be implemented by units of the computer or of the device.

### BRIEF DESCRIPTION OF THE DRAWINGS

FIG. 1 shows a schematic representation of a vehicle having a device for representing an object which lights up in a pulsed manner according to one exemplary embodiment of the present invention.

FIG. 2 shows a block diagram of a device for representing an object which lights up in a pulsed manner according to one exemplary embodiment of the present invention.

FIG. 3 shows a flow chart of a method for representing an object which lights up in a pulsed manner according to one exemplary embodiment of the present invention.

FIG. 4 shows a schematic representation of the merging of two images to form one recording of an object which lights up in a pulsed manner according to one exemplary embodiment of the present invention.

### DETAILED DESCRIPTION

In the following description of preferred exemplary embodiments of the present invention, identical or similar reference numerals are used for elements which are similarly operating and represented in the various figures, a repeated description of these elements being omitted.

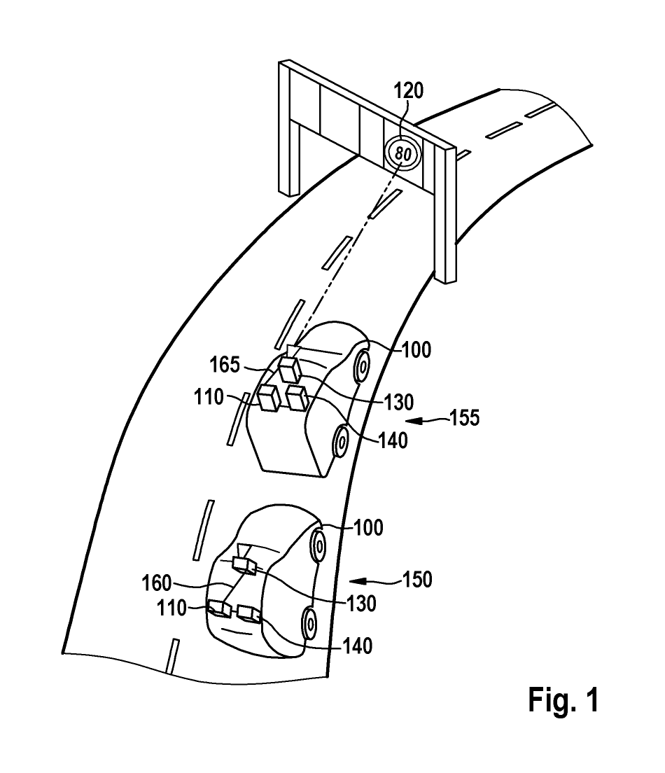

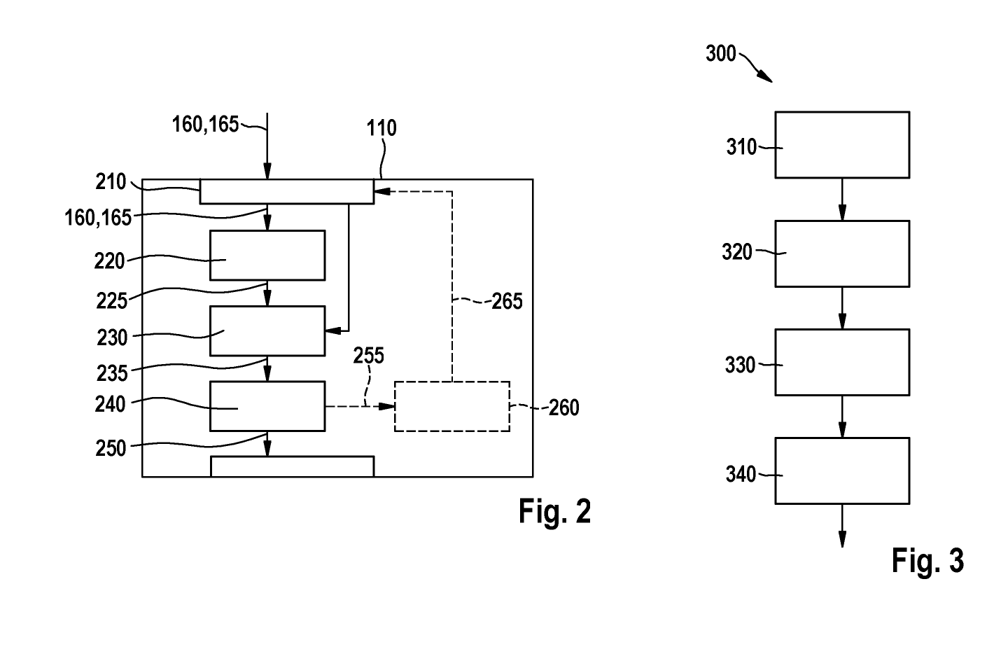

FIG. 1 shows a schematic representation of a vehicle 100 having a device 110 for representing an object 120 which lights up in a pulsed manner according to one exemplary embodiment of the present invention. In addition to device 110 for representing an object 120 which lights up in a pulsed manner, vehicle 100 includes a camera 130 and a driver assistance system 140. One viewing direction of camera 130 points in the driving direction of vehicle 100. In the representation in FIG. 1, vehicle 100 is depicted in a first position 150 and in a second position 155. Camera 130 is connected to device 110 for representing an object 120 which lights up in a pulsed manner. Device 110 is also connected to driver assistance system 140. In an exemplary embodiment not shown, device 110 is integrated into camera 130. In another exemplary embodiment not shown, driver assistance system 140 is integrated into camera 130. Alternatively, driver assistance system 140 and device 110 may be combined to form one unit. Camera 130 is designed to detect a first image 160 in first position 150. The camera is designed to detect a second image 165 in second position 155. Object 120 is depicted at least in one section of each of the two images 160, 165. Device 110 includes an interface for reading in images 160, 165. In an exemplary embodiment not shown, vehicle 100 includes a navigation system, which has stored the position of variable message signs. The navigation system is connected to device 110 and provides the information about the position of variable message signs to device 110. The information about the position of variable message signs may include a piece of information on the position relative to the road as well as to the height above the roadway. In following FIG. 2, device 110 for representing an object 120 which lights up in a pulsed manner is described in greater detail.

FIG. 2 shows a block diagram of a device 110 for representing an object 120 which lights up in a pulsed manner for a vehicle 100 according to one exemplary embodiment of the present invention. Device 110 may be situated in a vehicle 100 according to the description to FIG. 1. In the following description, the reference numerals for vehicle 100 and for object 120 are used in accordance with the preceding figure, even though these two elements are not represented in FIG. 2. Device 110 includes an interface 210 for reading in images 160, 165, a unit 220 for determining an apparent motion 225 of an object 120 between two recording times of the two images 160, 165, a unit 230 for transforming at least one of the two images 160, 165 using the apparent motion, in order to obtain two adapted images 235, in which object 120 is represented in the same size, and a unit 240 for merging the two adapted images 235, the object 120 being superimposed in a congruent manner during the merging in order to create recording 250 of object 120 which lights up in a pulsed manner. In an optional exemplary embodiment, device 110 includes a unit 260 for storing a synthetic image 255. Synthetic image 255 in this case may correspond to recording 250 of object 120 which lights up in a pulsed manner. Synthetic image 255 is generated by unit 240 for merging the two adapted images. Interface 210 for reading in images 160, 165, 265 is designed to read in a synthetic image 265, which has been saved in a preceding implementation of device 110. The following units 220, 230, 240 may process synthetic image 265 instead of image 165. Synthetic image 265 corresponds to synthetic image 255 saved in a preceding implementation of device 110.

FIG. 3 shows a flow chart of a method 300 for representing an object which lights up in a pulsed manner according to one exemplary embodiment of the present invention. Method 300 may be carried out on a device 110 for representing an object 120 which lights up in a pulsed manner, as was described in FIG. 1 and in FIG. 2. The method includes a step 310 for reading in images, a step 320 for determining an apparent motion of an object represented in the images, a step 330 of transforming at least one of the read-in images using the determined apparent motion, and a step 340 of merging the images adapted in step 330 in order to create a recording of the object which lights up in a pulsed manner.

In the case of the two images read in in step 310 of reading in at least two images, the object to be represented is depicted at least in one section of each of the at least two images. The two images were recorded at two different recording times. In step 320, an apparent motion of the object represented in at least one section of the images is determined, in order to transform at least one of the images read in in step 310 using the apparent motion in step 330 of transforming. Step 330 results in adapted images, in which the object represented in at least one section is represented in the same size and/or at the same position. In step 340 of merging, the adapted images generated in step 330 are merged, the object represented in at least one section of the adapted images being superimposed in a congruent manner. In step 340 of merging, a recording of the object which lights up in a pulsed manner is created.

In step 320, the method described may carry out a determination or prediction of the apparent motion (in the image) of an object. The apparent motion of an object at rest may be predicted based on the vehicle's own movement and the global position of the object. Under certain circumstances or assumptions, knowledge of partial components of the global position of the object, for example, the height above ground or the distance from the vehicle, is also sufficient in order to make a robust prediction. If necessary, this information may be extracted from the image, may be assumed as constant for particular categories of objects and/or may be pre-stored if necessary. The distance of the object from the vehicle may be extracted from the image, or may be directly measured using another sensor such as, for example, a stereo camera, a time-of-flight camera, a radar system or a comparable sensor. One advantage of predicting the apparent motion with this approach is that no explicit detection of the object is necessary, and that its effectiveness is independent of the performance of an object detector. If an adequately performing detector is available, then the apparent motion may alternatively be estimated by detecting the object in each image (frame) or by generating plausible object candidates and tracking them over time. This would be necessary, in particular, in order to detect moving objects, such as vehicle taillights, for example.

In step 330 of transforming, a distortion of the entire frame or of the image sections on which the object to be detected is located may take place, so that the object is either located in the same position in each image or at simply computable distances. The distortion results from a transformation of the image, which takes into consideration the optical properties of the camera and the perspective effects due to the vehicle's own movement. For a camera which approximates the pinhole camera model, this transformation is a homography. The transformation (distortion) may either be computed fully or alternatively in part (reduction of computing effort), or solved fully or alternatively in part by an optical, mechanical or MEMS system in the optical path in front of the camera sensor.

In step 340 of merging, the distorted frames, i.e., the transformed or adapted images, are merged with the aid of a local or pixel-by pixel image operator. This operator should prefer higher pixel intensities. In one exemplary embodiment, a maximum operator is used during merging. In the event of an optical and/or mechanical implementation, it may be implemented by an accumulation/storing of the radiation (for example, with the aid of a phosphor layer or the like).

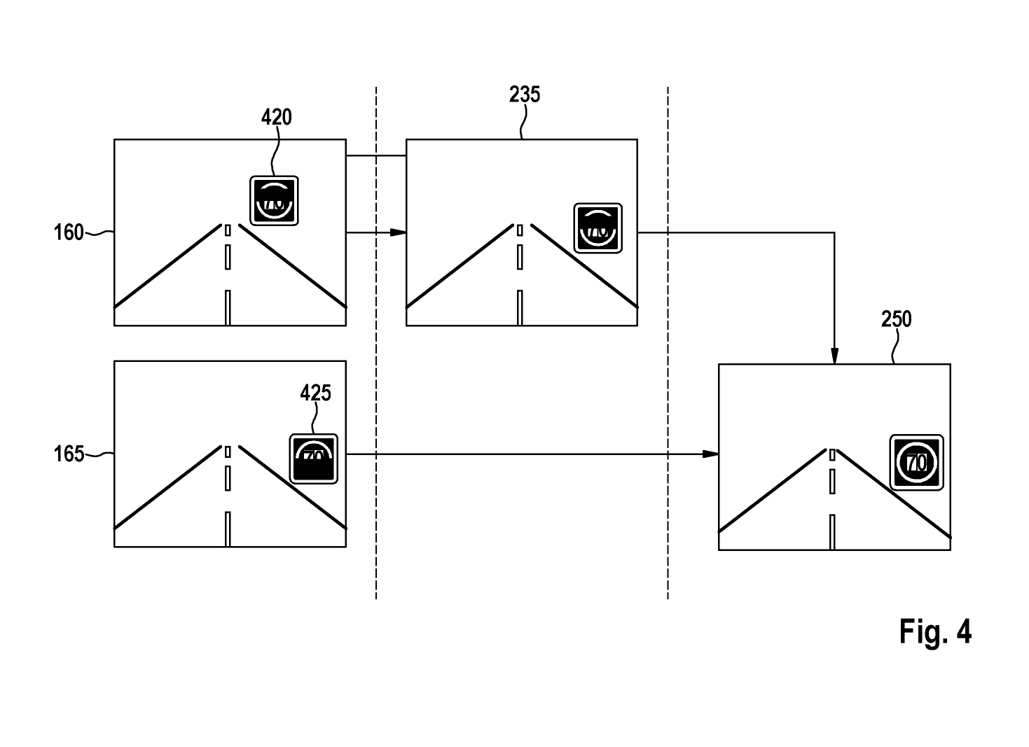

FIG. 4 shows a schematic representation of the merging of two images 160, 165 to form one recording 250 of an object which lights up in a pulsed manner according to one exemplary embodiment of the present invention. The representation of the merging of two images 160, 165 depicted schematically herein illustrates the method depicted in FIG. 3. The first image 160 may be a first image 160 recorded at first position 150 in FIG. 1. Analogously, second image 165 may be second image 165 recorded at second position 155 in FIG. 1. Recording 250 depicted in FIG. 4 may be recording 250 described in FIG. 2.

First image 160 shows a schematic representation of a road having a variable message sign. Due to the recording method and the pulsed light sources of the variable message sign, depiction 420 of the variable message sign includes an undetected strip. Second image 165 shows a schematic representation of a road having a depiction 425 of the variable message sign. Variable message sign 120 and the road may be the road having a variable message sign 120 shown in first image 160, second image 165 having been recorded at a second recording time. In this case, the second recording time of image 165 falls chronologically after a first recording time of first image 160. Depiction 425 of the variable message sign in second image 165 includes an undetected strip, comparable to depiction 420 of the variable message sign in first image 160. The undetected strip in first image 160 and the undetected strip in second image 165 relate to different sections of the variable message sign. In the schematic representation in FIG. 4, the step of determining an apparent motion is not represented. The apparent motion may be determined from first image 160 and second image 165. An adapted image 235 is created from first image 160 using a predetermined apparent motion. Adapted image 235 corrects a distortion between first image 160 and second image 165, so that the object, the variable message sign in the exemplary embodiment, is represented in the same size and same distortion in adapted image 235 and second image 165. Second image 165 and adapted image 235 of first image 160 are merged to form one recording 250. Recording 250 reproduces completely the detected variable message sign and thereby allows a detection of the variable message sign.

In other words, the information from multiple images (frames) recorded chronologically sequentially by the camera is utilized in order to generate a new, virtual adapted image (frame), in which objects which light up in a pulsed manner appear as constantly illuminating, i.e., approximately comparable to human perception. The new virtual image may be referred to as a synthetic image or as a recording of the object which lights up in a pulsed manner. In one exemplary embodiment, the synthetic image may be saved.

In FIG. 4, three phases of the method implemented in FIG. 3 for creating a recording of an object for a vehicle which lights up in a pulsed manner are depicted. Perpendicular lines separate the three phases from one another. In a first phase, which may be associated with step 320 of determining in FIG. 3, the movement of an object is determined or predicted in a sequence of images (frames). In the exemplary embodiment shown, the sequence is made up of two images. In a second phase, which may be associated with third step 330 of transforming in FIG. 3, the images, or at least certain sections thereof, are distorted, so that in each image, the object preferably has the same position and geometric properties such as, for example, scaling, shearing, etc. In a third phase, which may be associated with step 340 of merging in FIG. 3, the distorted images (frames) or image sections are superimposed in a congruent manner to form a new virtual or adapted image, the object appearing as constantly lighting up.

One aspect of the present invention is to detect objects which light up in a pulsed manner without changing the exposure time and frame rate of the camera. This is particularly advantageous if the recording parameters cannot be changed, for example, because a longer exposure time would result in a reduction in the image quality due to saturation or motion blur.

The exemplary embodiments described and shown in the figures are selected merely as exemplary. Different exemplary embodiments may be fully combined with one another or combined with respect to individual features. One exemplary embodiment may also be supplemented by features of an additional exemplary embodiment. Moreover, method steps according to the present invention may be repeatedly carried out and in a sequence other than that described.

1.-10. (canceled)

11. A method for creating a recording of an object which lights up in a pulsed manner for a vehicle, comprising:
reading in two images, the object being depicted at least in one section of each of the two images;
determining an apparent motion of the object between two recording times of the two images;
transforming at least one of the two images using the apparent motion in order to obtain two adapted images, in which the object is represented in the same size; and
merging the two adapted images, the object being superimposed in a congruent manner during merging in order to create the recording of the object which lights up in the pulsed manner.

12. The method as recited in claim 11, wherein in the step of reading in, an image of the two images is a synthetic image that at least one of:
has been created on the basis of past images, and
is the recording of then object which lights up in the pulsed manner.

13. The method as recited in claim 11, wherein the apparent motion is determined using a piece of information about a position change of a recording location of the two images.

14. The method as recited in claim 11, wherein the apparent motion is determined using an object type of the object.

15. The method as recited in claim 11, wherein the apparent motion is determined using a predetermined position of the object.

16. The method as recited in claim 11, wherein the apparent motion is determined using an object detection in each of the two images, in order to create the recording of a moving object which lights up in a pulsed manner.

17. The method as recited in claim 11, wherein in the step of determining, a piece of position information of the object per image is determined, and in which in the step of transforming, at least one of the two images is transformed using the position information, in order to obtain the two adapted images, in which the object is represented at an identical position.

18. The method as recited in claim 11, wherein:
in the step of reading in, at least one additional image is read in, the object being depicted in at least one section of the at least one additional image,
in the step of determining, the apparent motion of the object is determined using the recording time of the at least one additional image,
in the step of transforming, the at least one additional image is transformed using the apparent motion in order to obtain an additional adapted image,
in the step of merging, the at least one additional adapted image is merged with the two adapted images, and
the object is superimposed in a congruent manner in order to create the recording of the object which lights up in the pulsed manner.

19. A device for representing an object for a vehicle which lights up in a pulsed manner, comprising:
an interface for reading in two images, the object being depicted at least in one section of each of the two images;
a unit for determining an apparent motion of the object between two recording times of the two images;
a unit for transforming at least one of the two images using the apparent motion in order to obtain two adapted images, in which the object is represented in the same size; and
a unit for merging the two adapted images, the object being superimposed in a congruent manner during merging, in order to create the recording of the object which lights up in the pulsed manner.

20. A computer program product having program code for carrying out, when the program product is executed on a device, a method for creating a recording of an object which lights up in a pulsed manner for a vehicle, comprising:
reading in two images, the object being depicted at least in one section of each of the two images;
determining an apparent motion of the object between two recording times of the two images;
transforming at least one of the two images using the apparent motion in order to obtain two adapted images, in which the object is represented in the same size; and
merging the two adapted images, the object being superimposed in a congruent manner during merging in order to create the recording of the object which lights up in the pulsed manner.
